(19) United States
(12) Patent Application Publication
(10) Pub. No.: US 2009/0104417 A1
(43) Pub. Date: Apr. 23, 2009

(54) Magenta Dyes and Their Use in Ink-Jet Printing

(75) Inventors: Clive Edwin Foster, Manchester (GB); Rachel Anne James, Manchester (GB)

Correspondence Address: MORGAN LEWIS & BOCKIUS LLP, 1111 PENNSYLVANIA AVENUE NW, WASHINGTON, DC, 20004, US

(73) Assignee: FUJIFILM IMAGING COLORANTS LIMITED, Blackley, Manchester (GB)

(21) Appl. No.: 11/920,434

(22) PCT Filed: May 12, 2006
(86) PCT No.: PCT/GB2006/001775

§ 371 Date: Nov. 15, 2007

(30) Foreign Application Priority Data
May 27, 2005 (GB) 0510821.2

(51) Int. Cl. B32B 3/10; C09D 11/02; B05D 5/00; C09B 56/00

(52) U.S. Cl. 428/211.1; 106/31.48; 427/256; 534/653

(57) ABSTRACT

A metal chelate compound comprising a compound of the Formula (1) or a salt thereof:

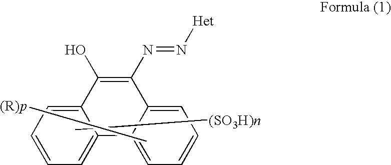

wherein:
Het is a nitrogen containing heterocycle selected from the group consisting of Formula (2), (3), (4), (5), (6) or (7):

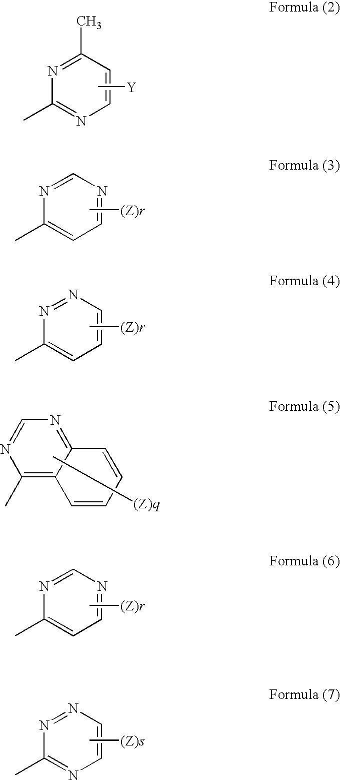

R is a substituent;
Y is CH₃ or COOH;
Z is a substituent,
n is 0 to 3;
p is 0 to 6;
q is 0 to 5;
r is 0 to 3; and
s is 0 to 2. Also compositions and inks, printing processes, printed material and ink-jet printer cartridges.

This invention relates to metal chelate compounds, compositions and inks, to printing processes, to printed substrates and to ink-jet printer cartridges.

Ink-jet printing is a non-impact printing technique in which droplets of ink are ejected through a fine nozzle onto a substrate without bringing the nozzle into contact with the substrate. The set of inks used in this technique typically comprise yellow, magenta, cyan and black inks.

With the advent of high-resolution digital cameras and ink-jet printers it is becoming increasingly common for consumers to print photographs using an ink-jet printer. This avoids the expense of conventional silver halide photography and provides a print quickly and conveniently.

While ink-jet printers have many advantages over other forms of printing and image development there are still technical challenges to be addressed. For example, there are the contradictory requirements of providing ink colorants that are soluble in the ink medium and yet do not run or smudge excessively when printed on paper. The inks need to dry quickly to avoid sheets sticking together after they have been printed, but they should not form a crust over the tiny nozzle used in the printer. Storage stability is also important to avoid particle formation that could block the tiny nozzles used in the printer especially since consumers can keep an ink-jet ink cartridge for several months. Furthermore, and especially important with photographic quality reproductions, the resultant images should not fade rapidly on exposure to light or common oxidising gases such as ozone.

International Patent Application WO2004/108834 discloses metal chelate azo dyes that are suitable for use in ink-jet printing. We have found that certain dyes of the type disclosed in this application provide prints that display unexpected advantages. In particular, these dyes provide prints with a combination of high chroma (i.e. brightness), high light-fastness and high fastness to oxidising gases (e.g. ozone).

Thus, according to a first aspect of the present invention there is provided a metal chelate compound comprising a compound of the Formula (1) or a salt thereof:

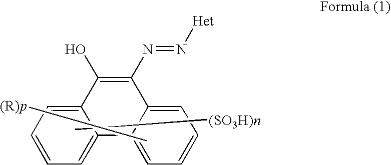

wherein:

Het is a nitrogen containing heterocycle selected from the group consisting of Formula (2), (3), (4), (5), (6) or (7):

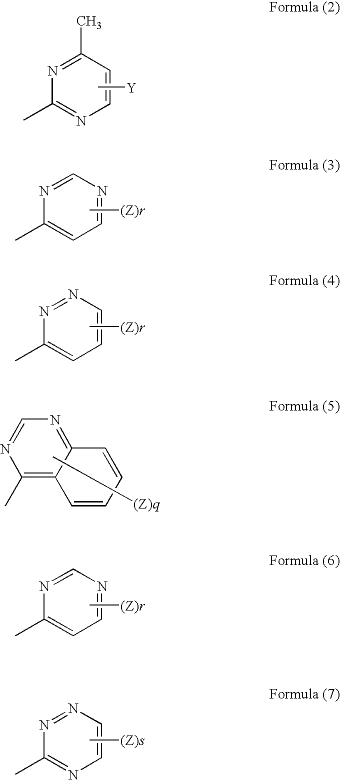

R is a substituent;

Y is CH₃ or COOH;

Z is a substituent;

n is 0 to 3;

p is 0 to 6;

q is 0 to 5;

r is 0 to 3; and

s is 0 to 2.

It is especially preferred that Het is of Formula (3) or (4).

R may be any substituent.

Preferably each R is independently selected from: optionally substituted alkyl (preferably C₁₋₄-alkyl), optionally substituted alkoxy (preferably C₁₋₄-alkoxy), optionally substituted aryl (preferably phenyl), optionally substituted aryloxy (preferably phenoxy), optionally substituted heterocycyl, polyalkylene oxide (preferably polyethylene oxide or polypropylene oxide), carboxy, phosphate, nitro, cyano, halo, ureido, —SO₂F, hydroxy, ester, —NR^{a}R^{b}, —COR^{a}, —CONR^{a}R^{b}, —NHCOR^{a}, carboxyester, sulfone, and —SO₂NR^{a}R^{b}, wherein R^{a} and R^{b} are each independently H or optionally substituted alkyl (especially C₁₋₄-alkyl). Optional substituents for any of the substituents described for R may be selected from the same list of substituents.

Z is preferably —OH, —Br, —Cl, —F, —CN, —NO₂, —PO₃H₂, —SO₃H, —CO₂H, optionally substituted phosphoramide, optionally substituted alkyl, optionally substituted alkenyl, optionally substituted alkynyl, optionally substituted aryl, optionally substituted aralkyl, —SR¹, —SO₂R¹, —SO₂NR²R³, —SOR¹, —OR¹, —C(O)R¹, —C(O)OR¹, —C(O)NR²R³, —NR²R³, —NHCOR¹. R¹, R² and R³ are each independently H, optionally substituted alkyl, optionally substituted alkenyl, optionally substituted alkynyl, optionally substituted aryl or optionally substituted aralkyl.

substituted alkenyl, optionally substituted alkynyl, optionally substituted aryl or optionally substituted aralkyl.

When Z is optionally substituted phosphoramide the phosphoramide is preferably substituted by optionally substituted alkyl, optionally substituted aryl or optionally substituted aralkyl. Preferred substituents include for example methyl, ethyl, n-propyl, iso-propyl, hydroxyethyl, optionally substituted phenyl or optionally substituted benzyl.

When Z is optionally substituted alkyl, the alkyl group is preferably optionally substituted C₁₋₄-alkyl, more preferably C₁₋₄-alkyl optionally substituted by halo, hydroxy, carboxy, sulfo or cyano. Examples include methyl, ethyl, n-propyl, iso-propyl, trifluoromethyl, hydroxyethyl, cyanoethyl, sulfopropyl and carboxyethyl. However, when Z is optionally substituted alkyl it is especially preferred that the alkyl group is methyl, ethyl or trifluoromethyl.

When Z is optionally substituted alkenyl, Z is preferably optionally substituted C₂-C₄ alkenyl.

When Z is optionally substituted alkynyl, Z is preferably optionally substituted C₂-C₆ alkynyl.

When Z is optionally substituted aryl the aryl group is preferably optionally substituted phenyl, optionally substituted naphthyl or optionally substituted heteroaryl. It is especially preferred that when Z is optionally substituted aryl it is optionally substituted phenyl or optionally substituted heteroaryl.

Preferred optional substituents on Z when Z is optionally substituted aryl include sulfo, carboxy, nitro, cyano, halo (preferably chloro), alkoxy (preferably C₁₋₆-alkoxy), alkyl ((preferably C₁₋₆-alkyl) optionally substituted by halogen (preferably fluoro), hydroxy, carboxy, phosphoric acid and sulfo. Especially preferred optional substituents on Z when Z is optionally substituted aryl are selected from C₁₋₄-alkyl, carboxy, phosphoric acid and sulfo.

When Z is optionally substituted aralkyl the aralkyl group is preferably optionally substituted benzyl.

It is especially preferred that Z is C₁₋₄-alkyl, especially methyl; halo, especially chloro; —SR¹ (a thioether), especially —SCH₃, carboxy, phenyl or sulfo; particularly methyl, chloro or —SCH₃.

Preferably n is 1 to 3, more preferably n is 2.

Preferably p is 0, 1 or 2, more preferably p is 0.

Preferably q is 0, 1 or 2, more preferably q is 0.

Preferably r is 1 to 3, more preferably r is 1 or 2.

Preferably s is 2.

Preferably n plus p is 2.

When q, r or s is 2 or more then each Z may vary independently.

The metal in the metal chelate compound is preferably one or more of: nickel, chromium, cobalt, copper, zinc, iron or manganese.

It is particularly preferred that the metal in the metal chelate compound is nickel or copper, especially nickel.

More preferably the compound of Formula (1) is of Formula (8):

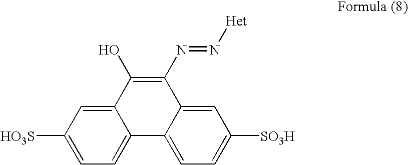

wherein Het is of Formula (2), (3), (4), (5), (6) or (7) as defined above. The properties and preferences for Het are as described above.

The compound of Formula (1) is preferably chelated to the metal in the ratio 1:1, 2:1, 2:2 or 2:3 respectively, especially in the ratio 1:1 or 2:1 respectively. The metal chelate compounds comprising a compound of Formula (1) may also comprise mixtures of these different chelated forms.

When there is more than one ligand of Formula (1) present in the metal chelate compound then the ligands of Formula (1) may be the same or different but preferably they are the same.

The metal chelate compound comprising a compound of Formula (1) may also comprise 1 or more additional ligands. These ligands may be coloured or colourless and when there is more than one they may be the same or different.

The metal chelate compounds comprising a compound of Formula (1), as described herein, may exist in tautomeric forms other than those shown in this specification. These tautomers are also included within the scope of the present inventions.

The metal chelate compounds comprising a compound of Formula (1) may also exist in different geometries e.g. octahedral or square planar. These different geometric forms are also included in the scope of the present invention.

It is especially preferred that the metal chelate compounds comprising a compound of Formula (1) are magenta in colour. Preferably the metal chelate compounds comprising a compound of Formula (1) have a chroma of at least 50 when printed on plain paper. Preferably the metal chelate compounds comprising a compounds of Formula (1) are water-soluble, more preferably they have a solubility in water at 20° C. of 0.5 to 15, more preferably 0.6 to 10% by weight.

The metal chelate compounds of the first aspect of the present invention provide prints which exhibit a high light-fastness, ozone fastness, wet fastness and good optical density.

Compounds of Formula (1) are preferably free from fibre reactive groups. The term fibre reactive group is well known in the art and is described for example in EP 0356014 A1. Fibre reactive groups are capable, under suitable conditions, of reacting with the hydroxyl groups present in cellulosic fibres or with the amino groups present in natural fibres to form a covalent linkage between the fibre and the dye. As examples of fibre reactive groups preferably not present in the compounds of the first aspect of the present invention there may be mentioned aliphatic sulfonyl groups which contain a sulfate ester group in the beta-position to the sulfur atom, e.g. beta-sulfato-ethylsulfonyl groups, alpha, beta-unsaturated acyl radicals of aliphatic carboxylic acids, for example acrylic acid, alpha-chloro-acrylic acid, alpha-bromoacrylic acid, propiolic acid, maleic acid and mono- and dichloro maleic; also the acyl radicals of acids which contain a substituent which reacts with cellulose in the presence of an alkali, e.g. the radical of a halogenated aliphatic acid such as chloroacetic acid, beta-chloro and beta-bromopropionic acids and alpha, beta-dichloro- and dibromopropionic acids or radicals of vinylsulfonyl- or beta-chloroethylsulfonyl- or beta-sulfatoethyl-sulfonyl-endo-methylene cyclohexane carboxylic acids. Other examples of cellulose reactive groups are tetrafluorocyclobutyl carbonyl, trifluoro-cyclobutenyl carbonyl, tetrafluorocyclobutylethenyl carbonyl, trifluorocyclobutenylethenyl carbonyl; activated halogenated 1,3-dicyanobenzene radicals; and heterocyclic radicals which contain 1, 2 or 3 nitrogen atoms in the heterocyclic ring and at least one cellulose reactive substituent on a carbon atom of the ring.

The compounds of Formula (1) and the metal chelate compound comprising a compound of Formula (1) may be in the free acid or salt form. Preferred salts are water-soluble, for example alkali metal salts, especially lithium, sodium, potassium, ammonium, substituted ammonium and mixed salts thereof. Preferred alkali metal salts are those with sodium or lithium ammonium and substituted alkyl ammonium salts.

Preferred ammonium and substituted ammonium salts have cations of the formula ⁺NV₄ wherein each V independently is H or optionally substituted alkyl, or two groups represented by V are H or optionally substituted alkyl and the remaining two groups represented by V, together with the N atom to which they are attached, form a 5- or 6-membered ring (preferably a morpholinyl, pyridinyl or piperidinyl ring).

Preferably each V independently is H or C₁₋₄-alkyl, more preferably H, CH₃ or CH₃CH₂, especially H.

Examples of cations include ⁺NH₄, morpholinium, piperidinium, pyridinium, (CH₃)₃N⁺H, (CH₃)₂N⁺H₂, H₂N⁺(CH₃)(CH₂CH₃), CH₃N⁺H₃, CH₃CH₂N⁺H₃, H₂N⁺(CH₂CH₃)₂, CH₃CH₂CH₂N⁺H₃, (CH₃)₂CHN⁺H₃, N⁺(CH₃)₄, N⁺(CH₂CH₃)₄, N-methylpyridinium, N,N-dimethyl piperidinium and N,N-dimethyl morpholinium.

Sodium, lithium, potassium, ammonium, or substituted ammonium salts are preferred because we have found that these salts provide prints which exhibit a high light-fastness when incorporated into an ink-jet printing ink.

The metal chelate compounds may be prepared using techniques that are well known in the art. For example a suitable method comprises mixing a solution of a metal salt and a solution of a compound of Formula (1), preferably in aqueous solution.

Normally 0.5 to 24 hours is sufficient for the metal salt to form a metal chelate compound with the compound of Formula (1).

The compounds of Formula (1) may be prepared by, for example, condensing a compound of the formula Het-NHNH₂ with a sulfonated phenanthrene quinone.

Sulfonation of the phenanthrene quinone is achieved by reacting phenanthrene quinone with oleum in sulfuric acid using conditions that would be well known to a skilled person.

Compounds of formula Het-NHNH₂ may be prepared by known literature methods, for example by reaction of a halo-heterocycle e.g. Het-Cl with hydrazine.

The product of the above process may be converted to a salt by conventional techniques as hereinbefore described. Alternatively the product may be isolated in its free acid form by acidifying the reaction mixture, preferably using a mineral acid, for example hydrochloric acid and when the product precipitates as a solid it may be separated from the mixture by filtration. Unwanted anions may be and preferably are removed from the product of the process by dialysis, osmosis, ultrafiltration or a combination thereof. Alternatively, the product solution is subjected to the above purification directly without isolation of the product.

The present invention also covers mixtures comprising two or more different metal chelate compounds of the present invention or salts thereof.

Furthermore, the compounds of the first aspect of the present invention may be mixed with other dyes, especially those listed in the International Colour Index, to adjust the shade or other properties as desired.

According to a second aspect of the present invention there is provided a composition comprising a metal chelate compound as described in the first aspect of the invention and a liquid medium.

Preferred compositions according to the second aspect of the invention comprise:
(a) from 0.01 to 30 parts of a metal chelate compound according to the first aspect of the invention; and
(b) from 70 to 99.99 parts of a liquid medium;
   wherein all parts are by weight

Preferably the number of parts of (a)+(b)=100.

The number of parts of component (a) is preferably from 0.1 to 20, more preferably from 0.5 to 15, and especially from 1 to 5 parts. The number of parts of component (b) is preferably from 80 to 99.9, more preferably from 85 to 99.5 and especially from 95 to 95 parts.

Preferably component (a) is completely dissolved in component (b). Preferably component (a) has a solubility in component (b) at 20° C. of at least 10%. This allows the preparation of liquid dye concentrates that may be used to prepare more dilute inks and reduces the chance of the dye precipitating if evaporation of the liquid medium occurs during storage.

The inks may be incorporated in an ink-jet printer as a high concentration magenta ink, a low concentration magenta ink or both a high concentration and a low concentration ink. In the latter case this can lead to improvements in the resolution and quality of printed images. Thus the present invention also provides a composition (preferably an ink) where component (a) is present in an amount of 2.5 to 7 parts, more preferably 2.5 to 5 parts (a high concentration ink) or component (a) is present in an amount of 0.5 to 2.4 parts, more preferably 0.5 to 1.5 parts (a low concentration ink).

Preferred liquid media include water, a mixture of water and organic solvent and organic solvent free from water. Preferably the liquid medium comprises a mixture of water and organic solvent or organic solvent free from water.

When the liquid medium (b) comprises a mixture of water and organic solvent, the weight ratio of water to organic solvent is preferably from 99:1 to 1:99, more preferably from 99:1 to 50:50 and especially from 95:5 to 80:20.

It is preferred that the organic solvent present in the mixture of water and organic solvent is a water-miscible organic solvent or a mixture of such solvents. Preferred water-miscible organic solvents include C₁₋₄-alkanols, preferably methanol, ethanol, n-propanol, isopropanol, n-butanol, sec-butanol, tert-butanol, n-pentanol, cyclopentanol and cyclohexanol; linear amides, preferably dimethylformamide or dimethylacetamide; ketones and ketone-alcohols, preferably acetone, methyl ether ketone, cyclohexanone and diacetone alcohol; water-miscible ethers, preferably tetrahydrofuran and dioxane; diols, preferably diols having from 2 to 12 carbon atoms, for example ethylene glycol, propylene glycol, butylene glycol, pentylene glycol, hexylene glycol and thiodiglycol and oligo- and poly-alkyleneglycols, preferably diethylene glycol, triethylene glycol, polyethylene glycol and polypropylene glycol; triols, preferably glycerol and 1,2,6-hexanetriol; mono-C₁₋₄-alkyl ethers of diols, preferably mono-C₁₋₄-alkyl ethers of diols having 2 to 12 carbon atoms, especially 2-methoxyethanol, 2-(2-methoxyethoxy)ethanol, 2-(2-ethoxyethoxy)-ethanol, 2-[2-(2-methoxyethoxy)ethoxy]ethanol, 2-[2-(2-ethoxyethoxy)-ethoxy]-ethanol and ethyleneglycol monoallylether; cyclic amides, preferably 2-pyrrolidone, N-methyl-2-pyrrolidone, N-ethyl-2-pyrrolidone, caprolactam and 1,3-dimethylimidazolidone; cyclic esters, preferably caprolactone; sulfoxides, preferably dimethyl sulfoxide; and sulfones, such as sulfolane.

Preferably the liquid medium comprises water and 2 or more, especially from 2 to 8, water-miscible organic solvents.

Especially preferred water-miscible organic solvents are cyclic amides, especially 2-pyrrolidone, N-methyl-pyrrolidone and N-ethyl-pyrrolidone; diols, especially 1,5-pentane diol, ethyleneglycol, thiodiglycol, diethyleneglycol and triethyleneglycol; and mono-C₁₋₄-alkyl and C₁₋₄-alkyl ethers of diols, more preferably mono-C₁₋₄-alkyl ethers of diols having 2 to 12 carbon atoms, especially 2-methoxy-2-ethoxy-2-ethoxyethanol.

Examples of further suitable liquid media comprising a mixture of water and one or more organic solvents are described in U.S. Pat. No. 4,963,189, U.S. Pat. No. 4,703,113, U.S. Pat. No. 4,626,284 and EP-A425,150.

When the liquid medium comprises organic solvent free from water, (i.e. less than 1% water by weight) the solvent preferably has a boiling point of from 300 to 200° C., more preferably of from 400 to 150° C., especially from 50 to 125° C. The organic solvent may be water-immiscible, water-miscible or a mixture of such solvents. Preferred water-miscible organic solvents are any of the hereinbefore-described water-miscible organic solvents and mixtures thereof. Preferred water-immiscible solvents include, for example, aliphatic hydrocarbons; esters, preferably ethyl acetate; chlorinated hydrocarbons, preferably CH₂Cl₂; and ethers, preferably diethyl ether; and mixtures thereof.

When the liquid medium comprises a water-immiscible organic solvent, preferably a polar solvent is included because this enhances the solubility of the dye in the liquid medium. Examples of polar solvents include C₁₋₄-alcohols.

In view of the foregoing preferences it is especially preferred that where the liquid medium is organic solvent free from water it comprises a ketone (especially methyl ethyl ketone) and/or an alcohol (especially a C₁₋₄-alkanol, more especially ethanol or propanol).

The organic solvent free from water may be a single organic solvent or a mixture of two or more organic solvents. It is preferred that when the liquid medium is organic solvent free from water it is a mixture of 2 to 5 different organic solvents. This allows a liquid medium to be selected that gives good control over the drying characteristics and storage stability of the ink.

Liquid media comprising organic solvent free from water are particularly useful where fast drying times are required and particularly when printing onto hydrophobic and non-absorbent substrates, for example plastics, metal and glass.

The liquid media may of course contain additional components conventionally used in ink-jet printing inks, for example viscosity and surface tension modifiers, corrosion inhibitors, biocides, kogation reducing additives and surfactants which may be ionic or non-ionic.

Although not usually necessary, further colorants may be added to the ink to modify the shade and performance properties. Examples of such colorants include C.I. Direct Yellow 86, 132, 142 and 173; C.I. Direct Blue 307; C.I. Food Black 2; C.I. Direct Black 168 and 195; and C.I. Acid Yellow 23.

It is preferred that the composition according to the invention is ink suitable for use in an ink-jet printer. Ink suitable for use in an ink-jet printer is ink that is able to repeatedly fire through an ink-jet printing head without causing blockage of the fine nozzles.

Ink suitable for use in an ink-jet printer preferably has a viscosity of less than 20 cP, more preferably less than 10 cP, especially less than 5 cP, at 25° C.

Ink suitable for use in an ink-jet printer preferably contains less than 500 ppm, more preferably less than 250 ppm, especially less than 100 ppm, more especially less than 10 ppm in total of divalent and trivalent metal ions (other than any divalent and trivalent metal ions bound to a colorant of Formula (1) or any other colourant or additive incorporated in the ink).

Preferably ink suitable for use in an ink-jet printer has been filtered through a filter having a mean pore size below 10 μm, more preferably below 3 μm, especially below 2 μm, more especially below 1 μm. This filtration removes particulate matter that could otherwise block the fine nozzles found in many ink-jet printers.

Preferably ink suitable for use in an ink-jet printer contains less than 500 ppm, more preferably less than 250 ppm, especially less than 100 ppm, more especially less than 10 ppm in total of halide ions.

A third aspect of the invention provides a process for forming an image on a substrate comprising applying ink suitable for use in an ink-jet printer, according to the second aspect of the invention, thereto by means of an ink-jet printer.

The ink-jet printer preferably applies the ink to the substrate in the form of droplets that are ejected through a small orifice onto the substrate. Preferred ink-jet printers are piezoelectric inkjet printers and thermal ink-jet printers. In thermal ink-jet printers, programmed pulses of heat are applied to the ink in a reservoir by means of a resistor adjacent to the orifice, thereby causing the ink to be ejected from the orifice in the form of small droplets directed towards the substrate during relative movement between the substrate and the orifice. In piezoelectric ink-jet printers the oscillation of a small crystal causes ejection of the ink from the orifice. Alternately the ink can be ejected by an electromechanical actuator connected to a moveable paddle or plunger, for example as described in International Patent Application WO00/48938 and International Patent Application WO00/55089.

The substrate is preferably paper, plastic, a textile, metal or glass, more preferably paper, an overhead projector slide or a textile material, especially paper.

Preferred papers are plain or treated papers which may have an acid, alkaline or neutral character. Glossy papers are especially preferred. Photographic quality papers are especially preferred.

A fourth aspect of the present invention provides a material preferably paper, plastic, a textile, metal or glass, more preferably paper, an overhead projector slide or a textile material, especially paper more especially plain, coated or treated papers printed with a metal chelate compound as described in the first aspect of the invention, a composition according to the second aspect of the invention or by means of a process according to the third aspect of the invention.

It is especially preferred that the printed material of the fourth aspect of the invention is a print on a photographic quality paper printed using a process according to the third aspect of the invention.

A fifth aspect of the present invention provides an ink-jet printer cartridge comprising a chamber and an ink suitable for use in an ink-jet printer wherein the ink is in the chamber and the ink is as defined in the second aspect of the present invention. The cartridge may contain a high concentration ink and a low concentration ink, as described in the second aspect of the invention, in different chambers.

The invention is further illustrated by the following Examples in which all parts and percentages are by weight unless otherwise stated.

### EXAMPLE 1

### Preparation of the Nickel Complex of

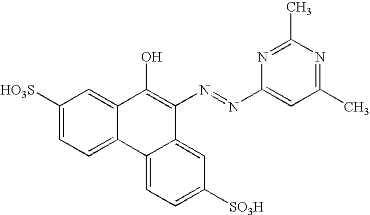

### Stage 1

### Preparation of Disulfophenanthrene Quinone

30% Oleum (189.7 g) was added dropwise, with agitation, to concentrated sulfuric acid (427 g at 98%, 4.27 mol). During this addition the temperature rose to 38° C. The resulting 3.1% oleum solution was stirred for 30 mins during which time the temperature dropped to 25° C. Phenanthrene quinone (106 g, 95%, 0.484 mol) was added slowly to the oleum over 20 mins with the temperature rising to 30° C. The reaction mixture was then heated to 100° C. over 30 mins and maintained at this temperature for 4 h. After this time HPLC showed conversion to mainly the monosulfo phenanthrene quinone. Further 30% oleum (200 g) was added over the course of 5 h and on completion of this addition the reaction was stirred at 100° C. for a further 5 h. The reaction mixture was then cooled to 70° C. and drowned out into ice/water with the temperature being maintained at less than 30° C. Concentrated sodium hydroxide solution (1414 g, 34.3 mol) was added over 2 h while monitoring the pH, and the temperature was allowed to rise to 90° C., until pH 5.4 when the solid product began to precipitate. The reaction was then allowed to cool to 30-35° C. during which time the pH rose to 7. Hydrochloric acid was added to pH3.5 and the mixture filtered. The resultant filter cake was then added to water (500 mLs) at 60° C. and heated to 80° C. The mixture was then filtered, washed with brine and dried in a vacuum over to provide 154.1 g of disulfophenanthrene quindne.

### Stage 2

### Preparation of the Ligand

Disulfophenanthrene quinone from stage 1 (0.0139 mol, 82% strength, 6.9 g) was dissolved in 2M HCl (200 mL) at room temperature. 2,4-Dimethyl-6-hydrazino pyrimidine (0.0139 mol, 1.91 g) was added and an immediate precipitate formed. The temperature was raised to 60° C. and after 1 hr at 60-70° C. a further 0.2 g. of the hydrazino pyrimidine was added. The mixture was then stirred at 60-70° C. for 2 days after which time HPLC showed mainly product and small quantities of both starting materials. The mix was cooled to room temperature and filtered. The filtrates were salted to 5% with sodium chloride and stirred for 1 h, a precipitate formed which was filtered to provide 5.36 g of an orange solid. This product was dissolved in water and dialysed to low conductivity then dried to give 3.3 g of ligand.

### Stage 3

### Preparation of Nickel Complex

The ligand (0.05 mol, 91% strength, 3.22 g) from stage 2 was dissolved in water at pH8 and nickel acetate (0.025 mol, 0.686 g) was added. The pH was kept at pH 8-9 by addition of 2N NaOH solution. The reaction mixture was stirred for 18 h at room temperature, the pH adjusted to 6 and the product precipitated by drowning into acetone (3-4 litre). The resultant slurry was allowed to settle for 10 min and then filtered. The solid was dissolved in water at pH 7 and dialysed to low conductivity to provide 2.52 g of metal complex.

### EXAMPLE 2 TO 7

The dyes in Table 1 were prepared using analogous procedures to those employed in Example 1. Where hydrazine compounds were not available from commercial sources they were prepared by methods well-known in organic chemistry, i.e. by reaction of the carbonyl compound with phosphorous oxychloride (POCl₃) and then hydrazine.

| | | | λₘₐₓ of Ni |
|---|---|---|---|
| Example | Hydrazine | Ligand | complex/nm |
| 2 | 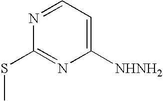 | 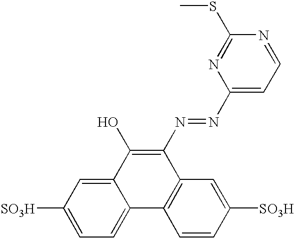 | 556 |
| 3 | 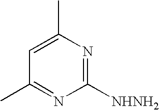 | 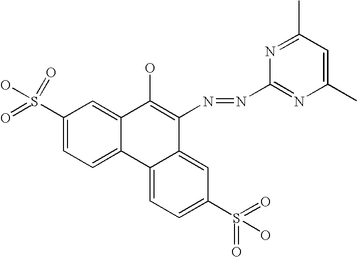 | 539 |
| 4 | 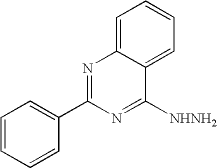 | 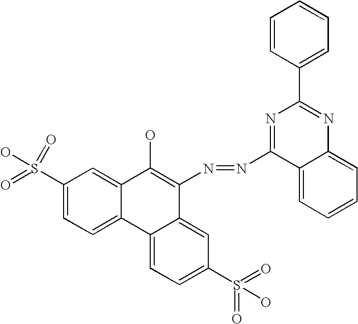 | 587 |
| 5 | 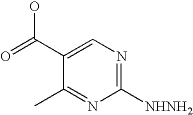 | 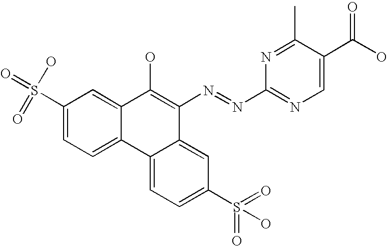 | 541 |
| 6 | 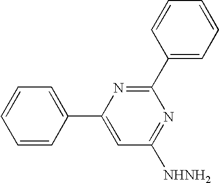 | 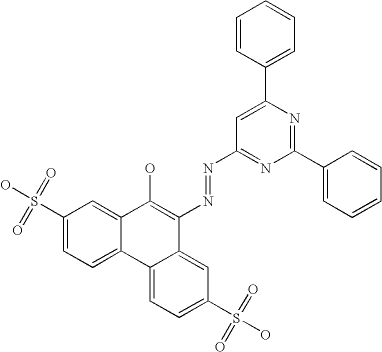 | 564 |
| 7 | 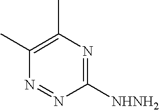 | 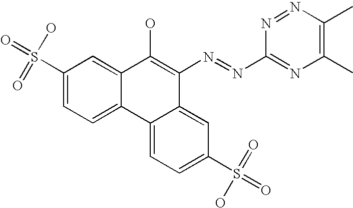 | 539 |

### EXAMPLE 8

### Preparation of the Nickel Complex of

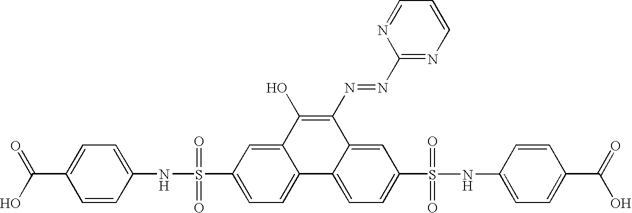

This dye (λₘₐₓ=548 nm) was made analogously to the dye described in Example 1, with the exception that the bisulfonamide shown below, was used in place of the disulfophenanthrene quinone.

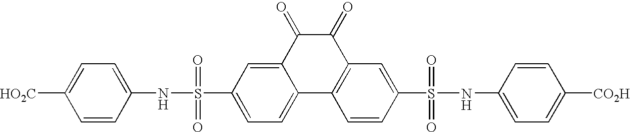

This bisulfonamide was prepared as follows. A suspension of disulfophenanthrene quinone (0.0186 mol, 11.0 g at 70% strength) in acetonitrile was heated to 80° C. and phosphorus oxychloride (3.8 equiv, 0.07 mol, 6.5 mL) added. The reaction mixture was then stirred at this temperature for 3 h. After this time an additional 5 mL of phosphorus oxychloride was added and the reaction heated at reflux overnight. After cooling the solution was poured onto ice, stirred and filtered to give the sulfonyl chloride as a brown solid (approx 12 g, damp solid). A solution of 4-amino benzoic acid (0.04 mol, 5.48 g) in dimethylacetamide (60 mL) was heated to 40° C. and the sulfonyl chloride added gradually over the course of 15 mins. The reaction was then stirred at 40° C. for 2 h. After this time the reaction mixture was drowned out into water and the pH adjusted to pH 4.5. The reaction was then filtered to give a brown solid which was redissolved in water at pH8, then re-precipitated at pH4.5 to provide the clean disulfonamido phenanthrene quinone (3.8 g, 30%) MS ES⁻ 605[M−H]⁻.

### COMPARATIVE EXAMPLES

Comparative Examples C1, C2 and C3 were prepared as described in Examples 1, 2 and 3 respectively of International Patent Application WO04/108834.

### Preparation of Inks

Inks were prepared from the Comparative Dyes and the Dyes of Examples 4 and 6, as shown in Table 1, by dissolving 3 g of a dye in 97 ml of a liquid medium consisting of 5 parts 2-pyrrolidone; 5 parts thiodiethylene glycol; 1 part Surfynol™ 465 and 89 parts water and adjusting the pH to between pH 8 to 9 with sodium hydroxide. Surfynol™ 465 is a surfactant from Air Products.

TABLE 2

| Dye of Example | Ink Example |
|---|---|
| 4 | 1 |
| 6 | 2 |
| Comparative Dye 1 | Ink C1 |
| Comparative Dye 2 | Ink C2 |
| Comparative Dye 3 | Ink C3 |

### Ink-Jet Printing

Inks prepared as described above were filtered through a 0.45 micron nylon filter and then incorporated into empty print cartridges using a syringe.

These inks were then printed on to Canon Premium PR101 Photo Paper (PR101).

The prints so formed, at 70% depth, were tested for ozone fastness by exposure to 1 ppm ozone at 40° C., 50% relative humidity for 24 hrs in a Hampden 903 Ozone cabinet. Fastness of the printed ink to ozone is judged by the difference in the optical density before and after exposure to ozone.

Light-fastness of the printed image was assessed by fading the printed image in an Atlas Ci5000 Weatherometer for 100 hours and then measuring the change in the optical density.

Optical density measurements were performed using a Gretag spectrolino spectrophotometer set to the following parameters:

| | |
|---|---|
| Measuring Geometry | 45°/0° |
| Spectral Range | 380-730 nm |
| Spectral Interval | 10 nm |
| Illuminant | D65 |
| Observer | 2° (CIE 1931) |
| Density | Ansi A |
| External Filler | None |

Ozone fastness and light fastness were assessed by the percentage change in the optical density of the print, where a lower figure indicates higher fastness. Results are shown in Table 3

TABLE 3

| Example | Light fastness | Ozone fastness |
|---|---|---|
| 1 | 17 | 8 |
| 2 | 15 | 7 |
| Ink C1 | 38 | 19 |
| Ink C2 | 38 | 12 |
| Ink C3 | 38 | 16 |

Table 3 shows that the ink of the present invention have higher light and ozone fastness than the comparative dyes.

### Further Inks

The inks described in Tables A and B may be prepared using the metal chelate compound of Example 1 as the dye component. Numbers quoted in the second column onwards refer to the number of parts of the relevant ingredient and all parts are by weight. The inks may be applied to paper by thermal or piezo ink-jet printing.

The following abbreviations are used in Tables A and B:

PG=propylene glycol

DEG=diethylene glycol

NMP=N-methylpyrollidone

DMK=dimethylketone

IPA=isopropanol

MeOH=methanol

2P=2-pyrollidone

MIBK=methylisobutyl ketone

P12=propane-1,2-diol

BDL=butane-2,3-diol

CET=cetyl ammonium bromide

PHO=Na₂HPO₄ and

TBT=tertiary butanol

TDG=thiodiglycol

TABLE A

| Dye | | | | | | | Na | | | | |
|---|---|---|---|---|---|---|---|---|---|---|---|
| Content | Water | PG | DEG | NMP | DMK | NaOH | Stearate | IPA | MEOH | 2P | MIBK |
| 2.0 | 80 | 5 | | 6 | 4 | | | | | 5 | |
| 3.0 | 90 | | 5 | 5 | | 0.2 | | | | | |
| 10.0 | 85 | 3 | | 3 | 3 | | | | 5 | 1 | |
| 2.1 | 91 | | 8 | | | | | | | | 1 |
| 3.1 | 86 | 5 | | | | | 0.2 | 4 | | | 5 |
| 1.1 | 81 | | | 9 | | 0.5 | 0.5 | | | 9 | |
| 2.5 | 60 | 4 | 15 | 3 | 3 | | | 6 | 10 | 5 | 4 |
| 5 | 65 | | 20 | | | | | 10 | | | |
| 2.4 | 75 | 5 | 4 | | 5 | | | | 6 | | 5 |
| 4.1 | 80 | 3 | 5 | 2 | 10 | | 0.3 | | | | |
| 3.2 | 65 | | 5 | 4 | 6 | | | 5 | 4 | 6 | 5 |
| 5.1 | 96 | | | | | | | | 4 | | |
| 10.8 | 90 | 5 | | | | | | 5 | | | |
| 10.0 | 80 | 2 | 6 | 2 | 5 | | | 1 | | 4 | |
| 1.8 | 80 | | 5 | | | | | | | 15 | |
| 2.6 | 84 | | | 11 | | | | | | 5 | |
| 3.3 | 80 | 2 | | | 10 | | | | 2 | | 6 |
| 12.0 | 90 | | | | 7 | 0.3 | | 3 | | | |
| 5.4 | 69 | 2 | 20 | 2 | 1 | | | | | 3 | 3 |
| 6.0 | 91 | | | 4 | | | | | | 5 | |

TABLE B

| Dye | | | | | | | | | | | |
|---|---|---|---|---|---|---|---|---|---|---|---|
| Content | Water | PG | DEG | NMP | CET | TBT | TDG | BDL | PHO | 2P | PI2 |
| 3.0 | 80 | 15 | | | 0.2 | | | | | 5 | |
| 9.0 | 90 | | 5 | | | | | | 1.2 | | 5 |
| 1.5 | 85 | 5 | 5 | | 0.15 | 5.0 | 0.2 | | | | |
| 2.5 | 90 | | 6 | 4 | | | | | 0.12 | | |
| 3.1 | 82 | 4 | 8 | | 0.3 | | | | | | 6 |
| 0.9 | 85 | | 10 | | | | | 5 | 0.2 | | |
| 8.0 | 90 | | 5 | 5 | | | 0.3 | | | | |
| 4.0 | 70 | | 10 | 4 | | | | 1 | | 4 | 11 |
| 2.2 | 75 | 4 | 10 | 3 | | | | 2 | | 6 | |
| 10.0 | 91 | | | 6 | | | | | | 3 | |
| 9.0 | 76 | | 9 | 7 | | 3.0 | | | 0.95 | 5 | |
| 5.0 | 78 | 5 | 11 | | | | | | | 6 | |
| 5.4 | 86 | | | 7 | | | | | | 7 | |
| 2.1 | 70 | 5 | 5 | 5 | 0.1 | 0.2 | 0.1 | 5 | 0.1 | 5 | |
| 2.0 | 90 | | 10 | | | | | | | | |
| 2 | 88 | | | | | | 10 | | | | |
| 5 | 78 | | | 5 | | | 12 | | | 5 | |
| 8 | 70 | 2 | | 8 | | | 15 | | | 5 | |
| 10 | 80 | | | | | | 8 | | | 12 | |
| 10 | 80 | | 10 | | | | | | | | |

1. A metal chelate compound comprising a compound of the Formula (1) or a salt thereof: 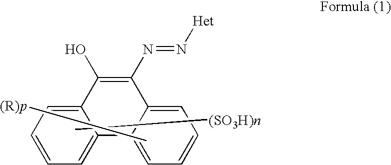
wherein:
Het is a nitrogen containing heterocycle selected from the group consisting of Formula (2), (3), (4), (5), (6) or (7): 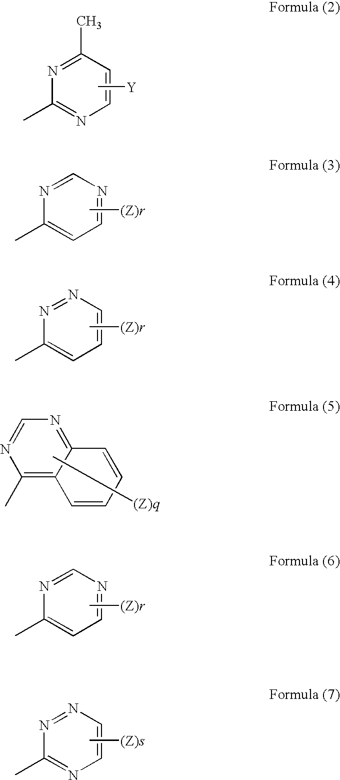
R is a substituent;
Y is CH₃ or COOH;
Z is a substituent;
n is 0 to 3;
p is 0 to 6;
q is 0 to 5;
r is 0 to 3; and
s is 0 to 2.

2. A metal chelate compound according to claim 1 wherein n is 2.

3. A metal chelate compound according to claim 1 wherein the compound of Formula (1) is of Formula (8): 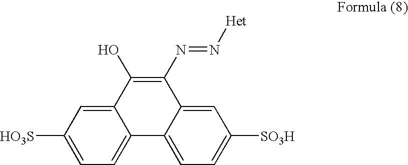
wherein Het is of Formula (2), (3), (4), (5), (6) or (7) as defined in claim 1.

4. A metal chelate compound according to claim 1 wherein Het is of Formula (3) or (4) as defined in claim 1.

5. A metal chelate compound according to claim 4 wherein r is 1 or 2.

6. A metal chelate compound according to claim 1 wherein Z is C₁₋₄-alkyl, halo, a thioether, carboxy, phenyl or sulfo.

7. A metal chelate compound according to claim 6 wherein Z is methyl, chloro or —SCH₃.

8. A metal chelate compound according to claim 1 wherein the metal in the metal chelate compound is nickel.

9. A composition comprising a metal chelate compound of Formula (1) as described in claim 1 and a liquid medium.

10. A composition which comprises:
(a) from 0.01 to 30 parts of a metal chelate compound according to claim 1; and
(b) from 70 to 99.99 parts of a liquid medium;
wherein all parts are by weight.

11. A composition according to claim 9 which is ink suitable for use in an ink-jet printer.

12. A process for forming an image on a substrate comprising applying ink suitable for use in an ink-jet printer, according to claim 11, thereto by means of an ink-jet printer.

13. A material printed with a metal chelate compound as described in claim 1.

14. A material according to claim 13 which is a print on a photographic quality paper printed using a process according to claim 12.

15. An ink-jet printer cartridge comprising a chamber and an ink suitable for use in an ink-jet printer, according to claim 11, wherein the ink is in the chamber.
